(19) United States
(12) Patent Application Publication
(10) Pub. No.: US 2003/0068942 A1
(43) Pub. Date: Apr. 10, 2003

(54) Polymer coated wall covering material

(76) Inventor: Dirk Kranendonk, Zutphen (NL)

Correspondence Address: OWENS CORNING, 2790 COLUMBUS ROAD, GRANVILLE, OH, 43023, US

(21) Appl. No.: 09/966,309

(22) Filed: Sep. 28, 2001

(51) Int. Cl. B32B 3/00; B32B 5/02; B32B 9/00; B32B 17/02; B32B 17/04; B32B 27/14

(52) U.S. Cl. 442/59; 428/195

(57) ABSTRACT

A polymeric wall covering material that is used to cover surface imperfections consists of a thermoplastic polymer coated to the surface of a nonwoven fiber tissue or mat. The polymeric coating on the fiber tissue or mat reduces paint consumption as compared with traditional glass fiber wall coating materials. In another preferred embodiment, the polymeric material contains a mineral filler to improve adhesion of a paint to the polymeric surface. In addition, an opacifying agent may be added to the polymeric material to improve hiding and improve paint adhesion. Further, a surface structure may be embossed to the applied polymeric coating during extrusion to facilitate painting with a roller-type applicator. Finally, the polymeric surface formed on the fiber tissue or mat may be subsequently treated with a corona discharge treatment to increase surface energy and adhesion.

### TECHNICAL FIELD AND INDUSTRIAL APPLICABILITY OF THE INVENTION

The present invention relates generally to wall coverings and more specifically to polymer coated wall-covering material.

### BACKGROUND OF THE INVENTION

Decorative wall coverings are well known in the art. These coverings are typically used to improve the aesthetic appearance of walls and/or to cover wall imperfections such as cracks, small holes and surface discolorations.

One such decorative wall covering material used in the prior art is a glass fiber tissue material. Glass fiber tissue is a preferred wall covering material because it has good mechanical properties such as rigidity and reinforcing capability. This glass fiber tissue material is typically painted to give an aesthetically pleasing surface. However, glass fiber tissue materials generally require a large amount of paint in order to adequately cover the glass fiber surface and give aesthetically pleasing results. In most cases, at least two coats of paint applied using a roller-type applicator are required. This is expensive both in terms of raw material costs and in terms of labor costs.

It is thus highly desirable to provide a glass fiber tissue wall covering material that can be painted in one coat with good adhesion and an aesthetically pleasing surface.

### SUMMARY OF THE INVENTION

An object of the present invention is to reduce the paint consumption used to cover glass fiber tissue used in wall covering materials to give an aesthetically pleasing surface.

In one preferred embodiment of the present invention, a polymeric coating is introduced to the outer surface of the glass fiber tissue material. The polymeric coating is a thermoplastic material that covers the surface of the glass fiber tissue, thereby reducing porosity significantly. This allows less paint to be applied to the surface to create an aesthetically pleasing outer surface. The polymeric material used in the polymeric coating is a thermoplastic polymer composition that exhibits good adhesion to both the glass fiber tissue and to the paint. The polymeric material also preferably has a degree of gas permeability to allow moisture to escape from underneath, thereby preventing mold growth in the wall covering material.

In another preferred embodiment of the present invention, the polymeric material used as a surface coating to the glass fiber tissue is filled with mineral filler such as calcium carbonate. The mineral filler acts to add structure to the polymer surface, thereby helping to prevent slippage of a roller type applicator used to paint the polymeric surface, thereby increasing painting efficiency.

In yet another preferred embodiment, a suitable opacifying agent such as titanium dioxide may be added to the polymeric coating composition, typically with the mineral filler, to create opacity in the polymeric coating, thereby reducing the amount of paint to be introduced to the outer surface that is necessary for hiding imperfections and color differences underneath.

In yet another preferred embodiment, specific surface treatments may be added to the polymeric film to increase adhesion of a subsequently applied wall paint to the polymeric film surface. This can be accomplished in two distinct ways. First, the surface energy of the polymeric coating may be increased to at least 30 dynes/cm by treating the surface with a corona discharge treatment. Also, an embossed pattern may be added to the polymeric surface during the extrusion process to add structure to the surface of the polymeric film, thereby increasing mechanical adhesion of a subsequently applied wall paint. Finally, both processes may be utilized together to further increase adhesion capabilities.

Other objects and advantages of the present invention will become apparent upon considering the following detailed description and appended claims, and upon reference to the accompanying drawings.

### BRIEF DESCRIPTION OF THE DRAWING

FIG. 1 is a logic flow diagram for producing and applying a polymeric wall coating to a wall;

FIG. 2 is a side view of a polymeric wall covering according to a preferred embodiment of the present invention; and

FIG. 3 is a side view of the polymeric wall covering of FIG. 2 applied to the surface of a wall and coated with paint to improve aesthetic appearance.

### DETAILED DESCRIPTION OF THE INVENTION

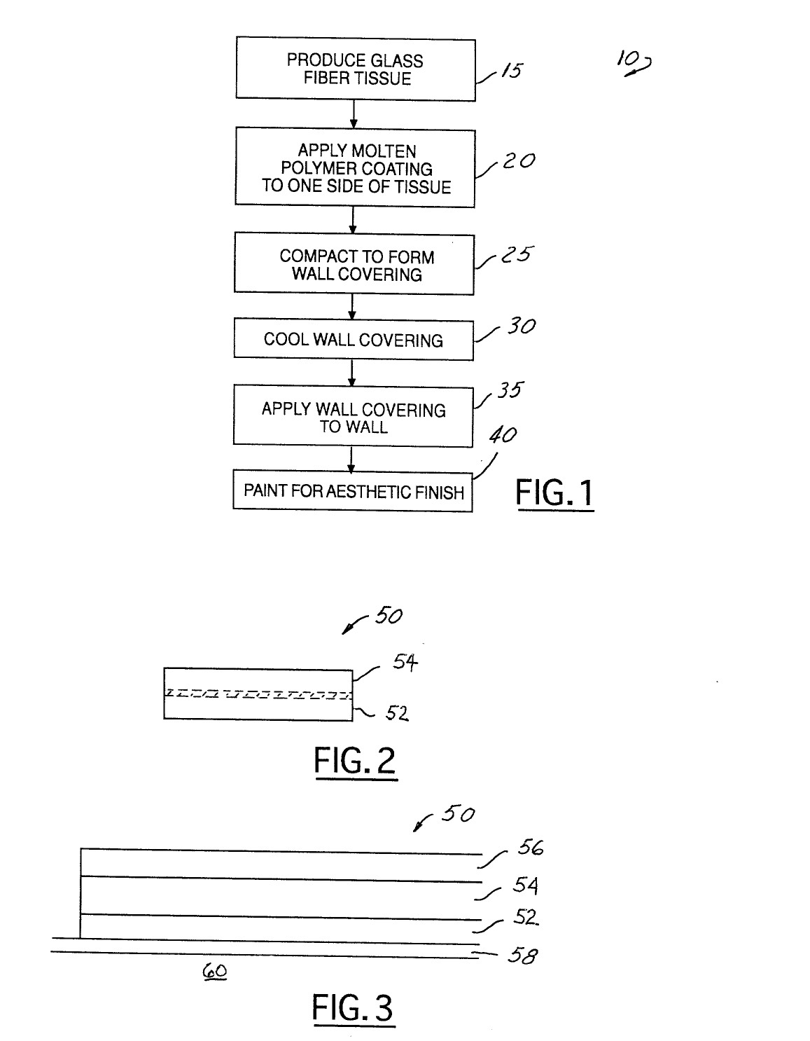

Referring now to FIG. 1, a logic flow diagram for preparing and applying a polymeric wall covering material to a wall or similar surface is shown generally as 10.

The preparation of the polymeric wall covering material begins by forming a fiber tissue in Step 15. Preferably, the fiber tissue or mat is formed by a wet laid process that is known in the art to impart a very fine fiber structure. However, fiber tissue or mats formed by a dry laid process are also contemplated. Details regarding the fiber type and length are described below and in FIG. 2.

Next, in Step 20, a molten matrix polymer material is applied to one side of the glass fiber tissue, preferably by means of extrusion. The molten matrix polymer material comes out of a slot die, and is fed into a nip between two cylinders. The preferred composition of the molten matrix polymer material is described below and in FIG. 2. In alternative embodiments, the polymeric film may be embossed within the extruder to impart a surface structure to the polymeric film.

Next, in Step 25, the molten matrix polymer material and fiber tissue are compacted together by introducing them through the nip in the extrusion line. The nip forces the molten matrix polymer material to adhere to the fiber tissue. Next, in Step 30, the molten matrix polymer material is cooled to form the polymeric wall covering material.

Also, the polymer film formed may be treated with a corona discharge treatment to increase the surface energy, or surface tension, to a value higher than 30 dynes/cm. The corona discharge treatment is a process whereby a metal bar, having a number of protruding pins throughout its entire length, is electrically charged at a high voltage and positioned close to the polymer film surface. A controlled discharge from the pins to the grounded part initiates a complex series of reactions involving ions and free radicals, eventually resulting in the introduction of polar groups to the surface of the polymer film, thereby increasing surface energy.

In Step 35, the wall covering material is applied to a wall or similar structure by introducing a coating of a suitable glue or adhesion material, either to the fiber tissue side of the polymeric wall covering or directly to the wall, and pressing the wall covering material to a wall. Finally, in Step 40, the polymeric coated surface of the polymeric wall covering may be painted to form an aesthetically pleasing surface.

Referring now to FIGS. 2, a side view of the polymer wall covering material 50 is depicted as having a fiber tissue 52 coated with a matrix polymeric material 54.

The fiber tissue 52 is a non-woven rigid fiber tissue that is typically used in the wall covering industry. The fiber tissue 52 has an area weight of around approximately 20 and 50 g/m², and preferably around 35 g/m², however other weight ranges may be used as is known in the art. Any type of rigid fiber may be used, either alone or in combination, including but not limited to carbon, metal, e-type glass, or other type of natural or synthetic fiber that are well known in the art that are not too soft or extensible. Preferably, the tissue 52 or mat is comprised of predominantly inorganic or mineral fibers, however a small amount of organic fibers may be introduced as well. One preferred fiber tissue is M35-GA7, based on the chopped fiber type CS 9501 11W-6 mm, both manufactured by Owens Corning.

The matrix polymeric material 54 is a thermoplastic polymer material that is capable of adhering to the fiber tissue 52 and provides a regular, paintable surface upon cooling. Further, the polymer material preferably resists scuffing and scratching and allows easy handleability. The polymeric material 54 is applied to a thickness between approximately 5 and 200 g/m², preferably between 30 and 60 g/m². One preferred matrix polymeric material 54 is high-density polyethylene (HDPE). However, other thermoplastic polymers such as, but not limited to, low-density polyethylene (LDPE) and polypropylene may be used as well. One preferred composition of the matrix polymer material 54 is shown below in Table 1. As described above, the surface of the polymeric material 54 is preferably treated with a corona discharge treatment to increase the surface energy to a value higher than 30 dynes/cm., thereby increasing the adhesion to regular, commercially available paints.

In another preferred embodiment, a mineral filler material is added in a range of approximately 1 to 50% by weight to the matrix polymer described above to form the polymer material 54. The mineral filler enhances the adhesion of an aesthetic paint placed on the visible surface of the wall covering 50 by creating structure and porosity on the coating's outer surface, thereby increasing adhesion mechanically.

The mineral filler also introduces a degree of gas permeability to the polymeric film 54, such that it allows moisture to escape through the polymeric film 54 and wall covering 50 to reduce or minimize mold growth. The water vapor transmission rate of the polymeric film 54 in the wall covering material 50 preferably should have a minimum transmission rate of approximately 1 gram/m² per day, according to DIN (German Industrial Standard) 52615, as measured by a wet cup process.

This mineral filler also allows a paint roller to roll, instead of slip, when applying an outer paint covering, thereby facilitating dispersal of paint across the entire polymer outer surface. One preferred mineral filler is calcium carbonate, however those skilled in the art will recognize that other mineral fillers may be used alone or in combination with the calcium carbonate. These include mica, talcum, and clay.

Further, a fine structure may be imparted to the outer surface of the polymeric material by embossing this polymeric material by means of an engraved cooling cylinder in the nip, onto which the molten polymeric material 54 is extruded. This fine surface structure further aids a paint roller to roll instead of slip when applying an outer paint covering, thereby facilitating dispersal of paint across the entire polymer outer surface.

In addition, a small amount of an opacifying agent may be added to the polymeric material 54. The opacifying agent functions to decrease the visibility of wall or surface imperfections through the wall covering 50 when applied to a wall (shown as 60 in FIG. 3). One preferred opacifying agent is titanium dioxide, however other opacifying agents known to those skilled in the art may be used. The amount of opacifying agent added to the polymeric material 54 composition is preferably enough to create an opacity of between approximately 70 and 90% in the wall covering, as measured by ISO 2471:1998.

In addition, other additives that are well known in the wall covering industry may be added to the formulation of the polymeric material 54 to improve various performance characteristics. For example, an anti-static or a fire retardant additive may be added to the formulation of the polymeric material 54.

To apply the polymer wall covering 50 to the wall 60, as shown in FIG. 3, a layer of paste or glue 58 is first applied to the tissue 52 side of the wall covering 50, or directly to the wall 60, and the wall covering 50 is then applied to the wall 60. The glue 58 is of a composition that is well known to a person skilled in the art. A layer of paint 56 may then applied to the visible polymeric coating 54 side of the wall covering material 50 to form an aesthetically pleasing surface. The paint 56 may be any commercially available paint that is used to cover wall covering materials and is also well known to one skilled in the art.

Table 1 illustrates a preferred composition of the polymeric material 54 containing a filler material and an opacifying agent.

TABLE 1

| | | WEIGHT |
|---|---|---|
| INGREDIENT | MANUFACTURER | PERCENTAGE |
| High-Density | | 45 |
| Polyethylene | | |
| Titanium dioxide | | 5 |
| masterbatch | | |
| Papermatch ® Weisz | A. Schulman | 50 |
| T7956-50 | | |

Papermatch®, manufactured by A. Schulman is a dispersion of ground calcium carbonate and ground titanium dioxide in high-density polyethylene. The polymeric material 54 listed in Table 1 is preferably extruded and applied to the tissue 52 at approximately 30-60 g/m².

The present invention offers many advantages over presently available fiber tissue wall coverings. First, the polymer material reduces the amount of paint consumption required to coat the wall covering material. In the embodiments shown in FIGS. 2 and 3 above, an approximate savings of 50 to 66% or more by volume or weight paint savings is realized, with the preferred embodiment shown requiring only one coat of paint to give an aesthetically pleasing surface as compared with the two or more coats that are generally necessary in the prior art.

Also, the addition of mineral fillers to the polymeric matrix material improves adhesion of the paint to the polymeric surface by increasing surface energy, by creating a certain porosity, and by imparting structure, i.e. non-smooth surface structure, to the visible polymeric surface. This non-smooth polymeric surface also allows paint rollers used to coat the polymeric surface with commercial paint to roll, not slide, thereby imparting a smooth and continuous paint surface requiring only one coat. Further, the embossing of a fine surface structure into the formed polymeric layer 54 further improves this aspect of paintability of the surface of the wall covering material 50.

Further, the addition of an opacifying agent reduces the visibility of surface imperfections such as stains or cracks in the wall. Thus, less paint may be required to hide these imperfections as compared with coatings without opacifying agents.

While the invention has been described in terms of preferred embodiments, it will be understood, of course, that the invention is not limited thereto since modifications may be made by those skilled in the art, particularly in light of the foregoing teachings.

What is claimed is:

1. A fiber reinforced wall covering material requiring less paint consumption to form an aesthetic outer surface comprising:
a non-woven fiber tissue or mat having an inner side and an outer side; and
a thermoplastic polymer coating applied to said outer side of said non-woven fiber tissue or mat.

2. The wall covering material of claim 1, wherein a visible surface of said thermoplastic polymer coating has a surface tension of at least approximately 30 dynes/cm.

3. The wall covering material of claim 1, wherein said thermoplastic polymer coating is applied to said non-woven tissue or mat at between approximately 5 and 200 g/m².

4. The wall covering material of claim 1, wherein said thermoplastic polymer coating is applied to said non-woven tissue mat at between approximately 30 and 60 g/m².

5. The wall covering material of claim 1, wherein said thermoplastic polymer coating comprises a matrix polymer resin selected from the group consisting of low density polyethylene, high density polyethylene, polypropylene, and combinations thereof.

6. The wall covering material of claim 5, wherein said thermoplastic polymer coating further comprises a mineral filler, wherein said mineral filler comprises between approximately 1 and 50% by weight of said thermoplastic polymer coating.

7. The wall covering material of claim 6, wherein said mineral filler is selected from the group consisting of calcium carbonate, mica, talcum, clay, and combinations thereof.

8. The wall covering material of claim 1, wherein said wall covering material has a water vapor transmission rate of at least approximately 1 gram/m2 per day.

9. The wall covering material of claim 5, wherein said thermoplastic polymer coating further comprises an opacifying agent, wherein the amount of said opacifying agent in said thermoplastic polymer coating is sufficient to create an opacity in the wall covering of between approximately 70 and 90%.

10. The wall covering material of claim 9, wherein said opacifying agent comprises titanium dioxide.

11. The wall covering material of claim 1, wherein said non-woven fiber tissue or mat is comprised of predominantly a first fiber type, said first fiber type selected from the group consisting of inorganic fibers and mineral fibers.

12. The wall covering material of claim 1, wherein said non-woven fiber tissue or mat comprises a non-woven fiber or mat having an area weight of approximately 20 to 60 g/m².

13. The wall covering material of claim 1, wherein said polymeric material comprises approximately a 45/5/50 by weight mixture of high-density polyethylene, titanium dioxide, and Papermatch®.

14. A method for reducing the amount of paint needed to coat a fibrous wall covering material, the fibrous wall covering material comprising a fiber tissue or mat having an inner surface and an outer surface, the method comprising the step of:
applying a first amount of a thermoplastic polymeric material to the outer surface of fiber tissue or mat to form a polymer coated wall-covering material.

15. The method of claim 14, further comprising the step of applying a corona discharge treatment to said polymer coated wall covering material to produce a surface tension on an outer visible polymeric surface of said polymer coated wall covering material of at least approximately 30 dynes/cm.

16. The method of claim 14, wherein the step of applying a first amount of a thermoplastic polymeric material to the outer surface of the fiber tissue or mat to form a polymer coated wall covering material comprises the step of applying between approximately 5 and 200 g/m² of a thermoplastic polymeric material to the outer surface of the fiber tissue or mat to form a polymer coated wall covering material.

17. The method of claim 14, wherein the step of applying a first amount of a thermoplastic polymeric material to the outer surface of fiber tissue or mat to form a polymer coated wall-covering material comprises the step of:
introducing a first amount of a thermoplastic polymeric material to the outer surface of the tissue fiber mat or through a flat extrusion die; and
compacting said first amount of said thermoplastic polymeric material and the tissue fiber or mat to form a polymer coated wall covering material.

18. The method of claim 14, wherein the step of applying a first amount of a thermoplastic polymeric material to the outer surface of fiber tissue or mat to form a polymer coated wall covering material comprises the step of applying a first amount of a thermoplastic polymeric material to the outer surface of fiber tissue or mat to form a polymer coated wall covering material, said thermoplastic polymeric material comprising a matrix polymer resin selected from the group consisting of a low density polyethylene polymer resin, a high density polyethylene polymer resin, a polypropylene polymer resin, and combinations thereof.

19. The method of claim 14, wherein the step of applying a first amount of a thermoplastic polymeric material to the outer surface of fiber tissue or mat to form a polymer coated wall covering material comprises the step of applying a first amount of a thermoplastic polymeric material to the outer surface of fiber tissue or mat to form a polymer coated wall covering material, said thermoplastic polymeric material comprising a matrix polymer resin and a mineral filler, wherein said mineral filler comprises between approximately 1 and 50% by weight of said thermoplastic polymeric material.

20. The method of claim 14, wherein the step of applying a first amount of a thermoplastic polymeric material to the outer surface of fiber tissue or mat to form a polymer coated wall covering material comprises the step of applying a first amount of a thermoplastic polymeric material to the outer surface of the fiber tissue or mat to form a polymer coated wall covering material, wherein an outer visible surface of said polymer coated wall covering material is embossed with a surface structure that may facilitate distribution of subsequently applied wall paint.

21. The method of claim 14, wherein the step of applying a first amount of a thermoplastic polymeric material to the outer surface of fiber tissue or mat to form a polymer coated wall-covering material comprises the step of:
applying a first amount of a thermoplastic polymeric material to the outer surface of fiber tissue or mat to form a polymer coated wall covering material, said thermoplastic polymeric material comprising a matrix polymer resin, a mineral filler, and an opacifying agent,
wherein said matrix polymer resin is selected from the group consisting of a low density polyethylene polymer resin, a high density polyethylene polymer resin, a polypropylene polymer resin, and combinations thereof;
wherein said mineral filler is selected from the group consisting of calcium carbonate, mica, talcum, clay, and combinations thereof; and
wherein said opacifying agent is titanium dioxide.
